(19) United States
(12) Patent Application Publication
(10) Pub. No.: US 2025/0196788 A1
(43) Pub. Date: Jun. 19, 2025

(54) ELECTRICAL CONNECTION FOR A SMOOTHING VEHICLE GLAZING, GLAZING AND VEHICLE COMPRISING THIS ELECTRICAL CONNECTION

(71) Applicant: SAINT-GOBAIN GLASS FRANCE, COURBEVOIE (FR)

(72) Inventors: Laurent LAMOUREUX, THOUROTTE (FR); Xavier DROUET, THOUROTTE (FR)

(21) Appl. No.: 18/835,254

(22) PCT Filed: Jan. 19, 2023
(86) PCT No.: PCT/EP2023/051277

§ 371 Date: Aug. 1, 2024

(30) Foreign Application Priority Data
Feb. 4, 2022 (FR) FR2200991

(51) Int. Cl. B60R 16/027

(52) U.S. Cl. CPC B60R 16/027

(57) ABSTRACT

A flexible electrical connection for a vehicle glazing that is movable in translation relative to a bodywork element of the vehicle, the flexible electrical connection having, along its length, an upstream connector attachable to an inner element fixed to the bodywork and a downstream connector attachable to a glass pane of the glazing. The flexible electrical connection includes a flexible ribbon cable including at least one conductive wire and/or at least one conductive strip and having a curved lateral shape at the connection with the upstream connector and with the downstream connector.

The present invention relates to a flexible electrical connection for a vehicle glazing that is movable in translation relative to a bodywork element of said vehicle, said flexible electrical connection having an upstream connector attachable to an inner element attached to said bodywork and a downstream connector attachable to a glass pane of said glazing.

This is a flexible electrical connection in the sense that this connection accompanies the glazing in its movement relative to the bodywork so that the electrical connection exists whatever the position of the glazing relative to the bodywork: open, closed or between these two states.

The present invention also relates to a vehicle glazing comprising a glass pane, means for enabling the mobility of said glass pane in translation relative to a bodywork element of said vehicle and at least one flexible electrical connection, as well as to a vehicle equipped with a glazing comprising a glass pane, means for allowing the mobility of said glass pane in translation relative to a bodywork element of said vehicle, and at least one flexible electrical connection.

It is known that a vehicle glazing may require an electrical supply, for example to make it possible to supply heating means of the glazing, such as a very fine network of wires or a layer or a stack of layers, or to make it possible to modify the transparency of the glazing and/or its tint.

International patent applications No. WO 2020/114639 and WO 2020/01949 disclose multilayer film glazing with electrically switchable optical properties. The applied voltage can be used to control the transmission of visible light through PDLC or SPD functional elements. A glazing with such functional elements can therefore be conveniently obscured electrically.

When such a glazing is movable relative to the bodywork, and in particular when it is movable by translation (or sliding), it is difficult to produce an electric supply that will correctly accompany the glazing in its movement relative to the bodywork, or relative to a bodywork part such as a door. It is especially difficult to ensure that this spot is reliable over time and lasts the entire lifetime of the vehicle.

The purpose of the present invention is therefore to propose a reliable, compact flexible electrical connection arrangement of a vehicle glazing that is movable in translation, a vehicle glazing arrangement movable in translation which comprises at least one such flexible electrical connection as well as a vehicle comprising at least one such glazing.

The invention is based on the discovery that a particular configuration of flexible electrical connection can make it possible to produce a reliable electrical connection, while being particularly compact, between a fixed bodywork element and a translatable glazing.

The present invention thus relates, in its broadest sense, to a method of making a vehicle glazing according to claim 1. This glazing is translatable relative to a bodywork element of said vehicle and said flexible electrical connection has, along its length, an upstream connector attachable to an inner element attached to said bodywork and a downstream connector attachable to a glass pane of said glazing. Said flexible electrical connection is remarkable in that it comprises a flexible ribbon cable comprising at least one conductive wire and/or at least one conductive strip and has a lateral shape curved on itself at the connection with said upstream connector and with said downstream connector.

A flexible ribbon cable is a long electrical connection element, having a width and thickness with the width greater than the thickness and which comprises two longitudinal ends; this is not an electrical cable in the sense that an electrical cable generally has a circular external section.

A ribbon cable is flexible in the sense that its general shape can be easily modified, in particular by applying forces of the same order of magnitude as the forces applied by human arms.

A connector is an element for electrically connecting and disconnecting the flexible ribbon cable at its longitudinal ends, upstream of an electrical system belonging to the vehicle and downstream from the glass pane.

The curved lateral shape is a shape whose curvature is observed in the lateral direction of the flexible ribbon cable, or transverse, that is, along its width, perpendicular to its length.

The present invention is based on the discovery that the application of a particular shape, here a lateral curve (that is, a curve of the entire cross-section of the flexible ribbon cable, perpendicular to the length of the flexible ribbon cable) at each of the two longitudinal ends of the flexible ribbon cable, makes it possible to bend the flexible ribbon cable along its length on itself between these two longitudinal ends, this bend being not very thick (the two plies, or portions of flexible electrical layers, are close to each other in the environment where they are superimposed). This bending of the flexible ribbon cable on itself, or fold, is movable: its position in the reference frame of the translatable glazing changes as a function of the position of the glass pane, that is, depending on the position of the downstream connector, assuming that the upstream connector is fixed in this reference frame. Even if the position of the fold changes along the flexible ribbon cable, between the two curved lateral shapes, its general shape is identical. There is thus no premature wear area and the reliability of the flexible electrical connection is very high.

Surprisingly, this bending creates a sort of rigidity of the flexible ribbon cable in the area where the curved lateral shape is present and this rigidity makes it possible to carry out a longitudinal fold of the flexible ribbon cable on itself in a portion located between the two curved lateral shapes, with a small final thickness of this fold, that is to say with a small radius of curvature of the fold. This fold of the flexible ribbon cable on itself over a small thickness makes it possible to produce a “path” of the flexible ribbon cable during the sliding of the glazing, that is to say a total volume occupied by the flexible electrical connection during the translations of the glazing, which is small. The space required for the flexible electrical connection is therefore reduced.

This reduced bulk makes it possible both to position the flexible electrical connection in a reduced hidden volume (such as, for example, inside an upright of a vehicle door or inside a vehicle roof) and both to prevent premature wear of the flexible ribbon cable. Indeed, if the flexible ribbon cable is in contact with an edge of the glass pane, that is, a corner between, on the one hand, an exterior or interior face and on the other hand an edge, it can be damaged by repeated contact with this edge; by providing for the flexible ribbon cable to fold over itself in a narrow volume, it is prevented that the flexible ribbon cable comes into contact with an edge of the glass pane and the premature wear of the flexible ribbon cable is thus prevented.

To facilitate this folding of the flexible ribbon cable on itself, these two curves are preferably in the same direction when the flexible ribbon cable is considered flat (without any fold). To facilitate the assembly, these two curves are preferably in the same direction (that is to say with the same angle), when the flexible ribbon cable is considered flat.

Preferably, the flexible electrical connection consists of said flexible ribbon cable, of said upstream connector attachable to an inner element attached to said bodywork and of said downstream connector attachable to a glass pane of said glazing; there is no connector, or intermediate element, between the upstream connector and the downstream connector. The flexible electrical connection is thus very simple and very reliable. It is also very lightweight.

During its use, when said flexible ribbon cable is observed along its length, it thus has two curved lateral shapes (the sheet is curved on itself laterally at each of its ends) and a fold that is situated longitudinally between these two curved lateral shapes.

When the flexible ribbon cable is observed to be bent on itself (folded), the two curves preferably have a plane of symmetry, like a chiral molecule. Thus, the fold always has the same shape and the risk of creating a zone of weakness in the flexible ribbon cable is reduced.

A fold of said flexible ribbon cable is it bending on itself, to 180°. Preferably, during its use, there is only one fold; it is always present and does not disappear, regardless of the position of the glass pane (open, closed, or between them).

At the location of this longitudinal fold, the flexible ribbon cable is substantially flat laterally: its cross-section has a non-curved, or flat, shape; this flat shape participates in the reliability in time: at the location where the ribbon cable is flat and bent longitudinally, its internal stresses are oriented only along the length and there is no internal stresses along the width; if the flexible ribbon cable was curved on itself laterally at the location of the longitudinal fold, the internal stresses would be oriented both along its length and along its width; over time, this fatigue would damage the material of the flexible ribbon cable and increase the risk of breakage.

It is possible to configure the flexible ribbon cable directly so that it already has, for example, by a specific molding operation of the flexible ribbon cable, a curved lateral shape at the connection with said upstream connector and with said downstream connector.

Preferably, so that the flexible ribbon cable has a curved lateral shape which remains identical all along its life at the connection with said upstream connector and with said downstream connector, said upstream connector and said downstream connector each comprise a receiving surface which is in contact with said flexible ribbon cable and which is curved laterally; thus, it is the receiving surface of the connectors that applies the curved lateral shape at both ends of the flexible ribbon cable.

Preferably, to facilitate the electrical connection, said receiving surface of said upstream connector and/or said downstream connector (and preferably both) is curved longitudinally and ends at a proximal end (close to the glass pane or inner element attached to the bodywork) by a flat part. This configuration further participates in achieving great compactness.

Preferably, to facilitate the bending of said flexible ribbon cable on itself (to facilitate the completion of the fold), at least one of said curved lateral shapes, and preferably each curved lateral shape, has, seen in cross-section, a general V-shape (with a single curvature point, preferably located in the middle of the width of said flexible ribbon cable), with an angle between the two wings of the V which is between 60° and 120°, or even between 80° and 100°; preferably 90°.

The present invention also relates to a vehicle glazing comprising a glass pane, means for enabling the translational mobility of said glass pane relative to a bodywork element of said vehicle, and at least one flexible electrical connection according to the invention, wherein said downstream connector is attached to said glass pane.

This attachment can be carried out by clipping or by in situ manufacturing of the upstream connector on the glass pane.

The reliability over time of the glazing is increased because the reliability of the flexible electrical connection is increased.

Preferably, for this glazing, said flexible ribbon cable has two curved lateral shapes (the sheet is curved on itself laterally at each of its ends) and a substantially flat fold, which is situated longitudinally between these two curved lateral shapes.

Said glass pane has a line of sight that, when the glazing is considered vertically, produces a separation between on the one hand a hidden part of the glass pane that is located under said line of sight and which is intended to be hidden inside a bodywork part regardless of the position of said glass pane relative to this bodywork part, and on the other hand, a visible part of the glass pane that is situated above said line of sight, said hidden part of the glass pane comprising at least one fastening zone for fastening said glass pane to said means for allowing mobility.

Said glazing thus comprises a line of sight which, although it constitutes a reference relative to the use of the glazing, belongs to the glazing as such, and is distinct from the final use of the glazing in the sense that this line is an item of data provided as soon as the glazing is designed; it is visible in the design and manufacturing of the glazing.

The expression “edge” or “end face” designates the narrow side of a sheet, which is located substantially transversely between the two main faces of a sheet.

The attachment of the downstream connector to said glass pane is preferably done near an edge of the glass pane; preferably in a hidden part of the glass pane.

Preferably, said glass pane comprises electrical means, such as means for heating said glass pane and/or means for lightening and darkening said glass pane and/or for changing the hue of said glass pane.

To facilitate the manufacture of the glazing, said downstream connector can be attached to the means to allow the translational mobility of said glass pane.

Said means for enabling the mobility of said glass pane may comprise, within the meaning of the present invention, one or more pane-carriers, one or more holders, one or more rails, or runners.

Preferably, said means for enabling the mobility of said glass pane in vertical translation with respect to a door of said vehicle comprises a pane-holder having a U-shaped part encasing a part of said glass pane.

Said means for allowing the mobility of said glass pane may comprise one or more holes partially or totally passing said glass pane (that is to say over a part of the thickness of an element composing it in the fastening zone or the totality of the thickness of this element in the fastening zone).

Said glass pane can be completely monolithic (consisting of a single sheet of glass or plastic) or be completely multiple (consisting of several sheets of glass or plastic) or else be partially multiple in part, such as for example in the visible and partially monolithic part, such as for example in the hidden part. The concept of a “multiple pane” relates in particular to the lamination, that is to say the presence of at least three sheets: an exterior glass sheet, an interior glass sheet, and an interlayer sheet of adhesive material located between these two sheets.

When the glass pane is partially or completely laminated, it comprises, in its laminated part, from the exterior to the interior, at least, in this order: an exterior glass sheet, an adhesive interlayer then an interior glass sheet; however, it is possible for at least one other sheet to be inserted between the exterior glass sheet and the adhesive interlayer or between the adhesive interlayer and the interior glass sheet. In a variant, the glass pane preferably consists of the exterior glass sheet, the adhesive interlayer and the interior glass sheet, with no other sheet.

Advantageously, the thickness of said exterior sheet is between 2.85 mm and 4.85 mm. Preferably, said exterior glass sheet has surface stresses between 80 and 200 MPa for a thickness of said exterior glass sheet of between 2.85 and 4.85 mm.

Advantageously, the thickness of said interior glass sheet is between 0.30 mm and 2.60 mm. It may in particular be between 0.70 mm and 2.10 mm, or even between 1.0 mm and 1.60 mm.

In a preferred embodiment of the present invention, the thickness of said interior glass sheet is between 1.00 mm and 1.20 mm.

Advantageously, said exterior glass sheet has surface stresses at most of 20 MPa, 30 MPa and 40 MPa, respectively, for a thickness of said exterior glass sheet of about 1.1 mm, about 1.6 mm and about 2.1 mm. The term “about” here refers to a value considered by the person skilled in the art as a standard value, even if locally this value can vary within a range of plus or minus 10%.

The interlayer sheet of adhesive material is, for example, a polyvinylbutyral (PVB) sheet that is between 0.30 and 1.50 mm thick, for example 0.78 mm thick.

In the case where the glass pane includes one or more other sheets in addition to the three mentioned previously, the exterior glass sheet is the outermost sheet of the laminated glass pane.

The present invention also relates to a vehicle equipped with a glazing comprising a glass pane according to the invention, means for allowing the translational mobility of said glass pane relative to a bodywork element of said vehicle and at least one flexible electrical connection according to the invention, wherein said upstream connector is attached to an inner element attached to said bodywork and said downstream connector is attached to said glass pane.

The reliability over time of the vehicle is increased because the reliability of the flexible electrical connection is increased. The useful space inside the vehicle is increased because the bulk of the flexible electrical connection is reduced.

Said flexible ribbon cable preferably has, along its length, a fold having a radius of curvature comprised between 0.2 and 20.0 mm, preferably between 5.0 and 15.0 mm.

In this vehicle, said glass pane preferably comprises means for heating said glass pane and/or means for lightening and darkening said glass pane and/or for changing the hue of said glass pane.

In this vehicle, preferably, said flexible ribbon cable, and preferably each flexible ribbon cable, extends along its length in a direction parallel to an essential component of the direction of translation of said glass pane; i.e., that:
if the glass pane translates or slides essentially along the vertical (completely along the vertical without any component along the horizontal or with a small component along the horizontal), then the flexible ribbon cable extends in the vertical; and
if the glass pane translates or slides essentially along the horizontal (completely along the horizontal without any component along the vertical or with a small component along the vertical), then the flexible ribbon cable extends in the horizontal.

In this vehicle, said inner element is preferably an inner guide for said flexible ribbon cable, to prevent it from going further inward; it may belong to the glazing as provided for integration into the vehicle.

In this vehicle, preferably, the upstream connector is fixed in the reference frame of said translatable glazing.

The present invention has been developed for glazings incorporated in doors having lateral jambs and an upper jamb at the glazing when the latter is closed.

Advantageously, the present invention makes it possible to produce a reliable, compact flexible electrical connection for a vehicle glazing. This connection is also lightweight and easy to manufacture. The glazing itself is also lightweight and easy to manufacture. The vehicle equipped with such a flexible electrical connection or such a glazing is also lightweight and easy to manufacture, the bulk of the electrical connection is reduced and saves space inside the vehicle.

Advantageously, the glass pane of the glazing according to the invention is non-flat, the flexible electrical connection according to the invention is particularly efficient when the sliding movement of the glass pane is complex (with translation components in two directions of the space).

Advantageously, the glazing according to the invention is not a glazing that is rotatable relative to a bodywork.

The present invention will be better understood from reading the detailed description hereinafter of non-limiting exemplary embodiments and from the appended schematic figures:

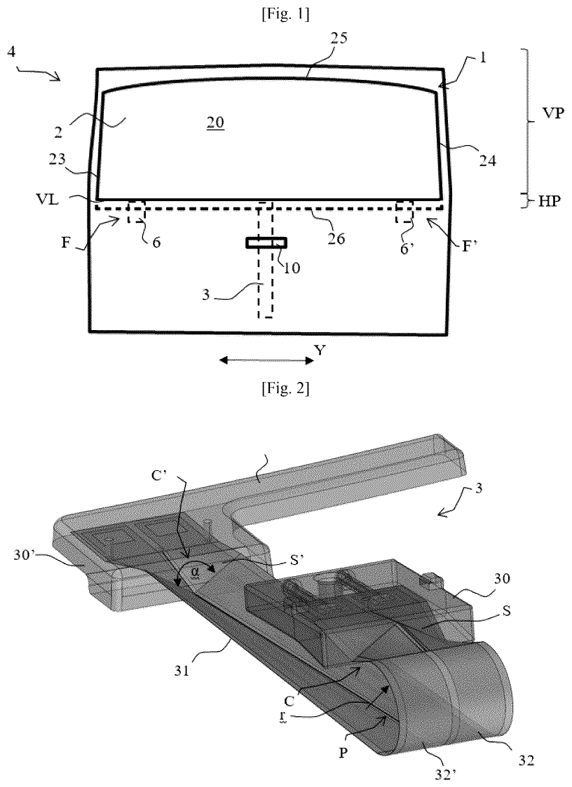

FIG. 1 illustrates a schematic exterior face view of a rear door (tailgate) of a motor vehicle opening by rotation relative to a horizontal axis, said door comprising a vertically translatable glazing and comprising two fastening areas as well as a flexible electrical connection;

FIG. 2 illustrates a perspective transparency view of a flexible electrical link;

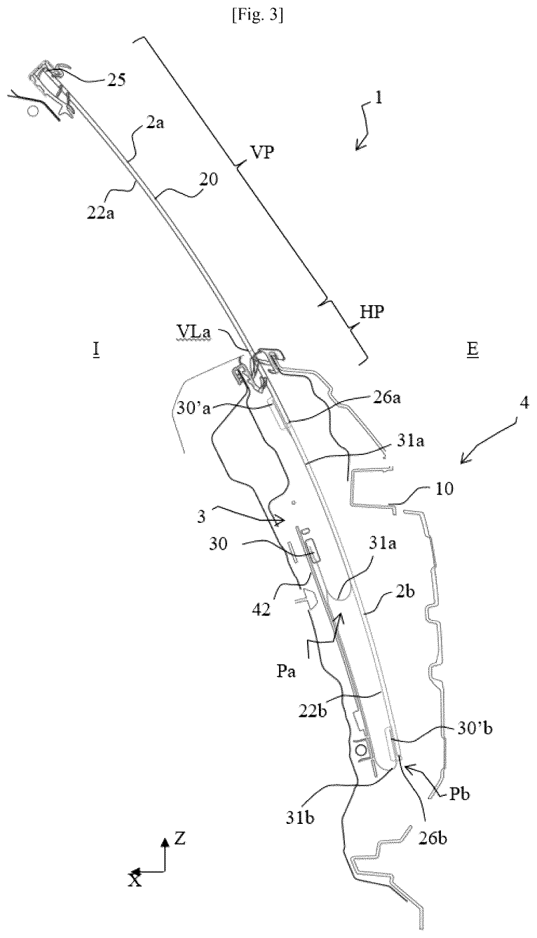

FIG. 3 illustrates a vertical cross-sectional view of a tailgate with the glazing in the high position (references ending in “a”), closed, and in the low, open position (references ending in “b”);

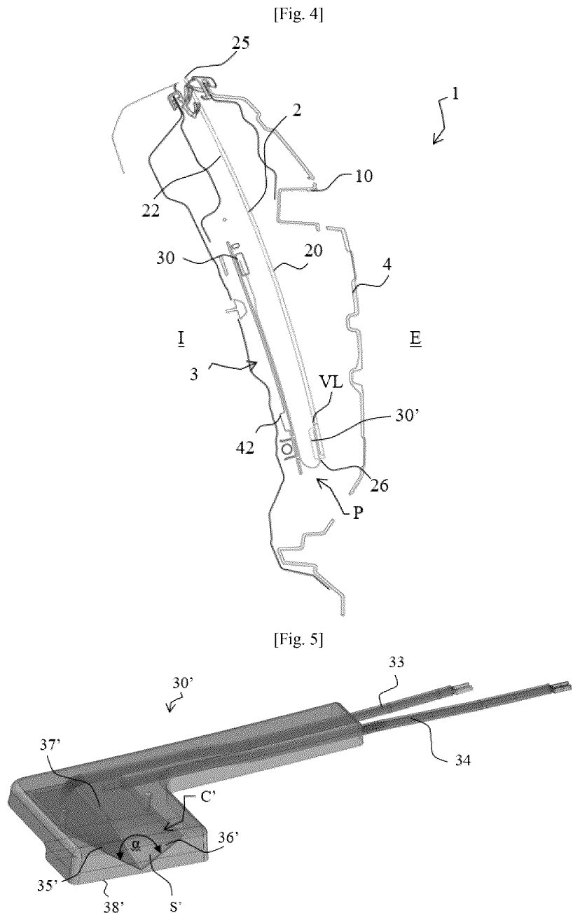

FIG. 4 illustrates a partial sectional view of FIG. 3 showing only the glazing in the low position, open; and

FIG. 5 illustrates a perspective view of a downstream connector.

Note that the various elements depicted are out of proportion to one another, for the sake of legibility.

FIG. 1 illustrates a rear door 4 of a motor vehicle, seen from the rear of the vehicle and from the outside. This door, or tailgate, is movable in rotation relative to a horizontal axis located here at the top; this mobility can be implemented by activating a handle 10. This door comprises a glazing 1 that can be moved in translation substantially according to the vertical between an open position wherein the glazing is located entirely or almost entirely in the interior of the door and a closed position wherein the glazing closes a glass pane opening of the door.

The situation of the glazing 1 in a rear door 4 is taken here by way of example, just like the fact that it is rotatable relative to a horizontal axis.

The door 4 could be a lateral door, and the glazing would then be a lateral vehicle glazing (which can be moved in translation with respect to this door substantially along the vertical between an open position wherein the glazing is located entirely or almost entirely in the interior of the door and a closed position wherein the glazing closes an opening of the door).

The glazing 1 can thus be a glazing movable relative to a bodywork part that is itself movable, such as a door.

The glazing 1 can also be a glazing movable relative to a fixed bodywork part, such as a lateral upright or a roof.

The glazing 1 can thus be:
a tailgate glazing, or “backlite”, or
a side door glazing, itself opening by rotation or sliding; or
a sunroof glazing.

The vehicle can thus be equipped with a plurality of glazings according to the invention. The vehicle may be a motor vehicle, or a truck, or any other type of vehicle.

Thus, in a closed position, this glazing 1 here embodies a vertical separation between an interior space I that is in the interior of the vehicle and an exterior space E that is on the exterior of the vehicle.

The notions “exterior” and “interior” are therefore respectively considered in the present document with respect to this exterior space E and this interior space I.

As the figures concern a rear glazing, the latter for the most part extends according to the axis generally referred to as the “Y-axis” of the vehicle, which is the transverse horizontal axis perpendicular to the longitudinal horizontal axis of the advance of the vehicle equipped with the glazing according to the invention as a rear glazing of the vehicle and which corresponds to the horizontal axis in the plane of the sheet in FIG. 1.

In the context of the present document, the concepts of “centripetal” and “centrifugal” are to be considered in the plane of the sheet in FIG. 1, or in a general plane of the glazing when it is considered flat, to be expressed relative to the center of the glazing, according to the Y and Z axes; the centripetal direction is in the direction of this center of the glazing whereas the centrifugal direction is away from this center of the glazing.

The mobility of the glazing 1 relative to the door 4 is essentially vertical in the sense that this mobility takes place along the Z-axis, optionally with a small component along the longitudinal horizontal axis as shown in FIGS. 3 and 4.

FIGS. 1, 3, and 4 shows that the glass pane 2 therefore has an external face 20 oriented toward the exterior space E, an internal face 22 oriented toward the interior space I, and a peripheral edge 21 situated between these two faces.

In FIGS. 1, 3, and 4, the dashed line, called “line of sight” or “limit of sight” VL, shows the top of the shell of the door inside which the glazing 1 slides. When the glazing is considered vertically, this line of sight VL creates a separation between, on the one hand, a hidden part of the glass pane HP that is located below the line of sight VL and that is intended to be hidden inside the door regardless of the position of the glass pane relative to said door and, on the other hand, a visible part of the glass pane VP that is located above the line of sight VL.

In the hidden part of the glazing, under the line LV, the glazing has one, and preferably here two, attachment zones F, F′, each zone being intended to accommodate means for allowing the mobility of the glass pane in vertical translation with respect to the door of the vehicle. In the finished glazing, each attachment zone F, F′ comprises a glass pane holder 6, 6′ that is fixed to the glass pane.

In the exemplary embodiments shown, the glazing 1 comprises a glass pane 2 that is curved (that is, not flat), which makes its translational movement more complicated.

The glass pane 2 can be completely monolithic (consisting of a single sheet of glass or plastic) or be completely multiple (consisting of several sheets of glass or plastic) or else be partially multiple in part, such as for example in the visible and partially monolithic part VP, such as for example in the hidden part HP.

The glass pane 2 has a first lateral rim 23, at left, a second lateral rim 24, at right, a top rim 25 and a bottom rim 26. The top rim 25 and the bottom rim 26 of the glass pane are arranged in the part of the glass pane oriented toward the roof and in the part of the glass pane oriented toward the ground on which the vehicle rests.

The glazing comprises, in addition to the glass pane, along at least part of at least one bottom rim 26, at least one glass pane holder 6, 6′ that is intended to accommodate a securing element, not shown, which has the purpose of allowing the glass pane holder to be attached in a movement system to raise and lower the glazing. On this subject, some documents talk of a “regulator” system.

The glazed unit, in its use configuration, thus preferably includes two glass pane holders 6, 6′, one in each fastening zone F, F′.

FIG. 3 shows the glass pane 2 in two positions:
the glass pane 2a corresponds to the “closed glass pane” position, when the glass pane 2 closes the opening provided here in the door; and
the glass pane 2b corresponds to the “open glass pane” position, when the opening provided here in the door is open.

FIG. 4 shows the glass pane 2 only in the “open glass pane” position, when the opening provided in the door is open.

As can be seen in FIGS. 1, 3 and 4, the glazing 1 comprises at least one flexible electrical connection 3, 3a, 3b, shown in FIG. 2, to supply the glazing 1 with electric current and/or an electrical signal.

The glazing 1 here comprises a single flexible electrical connection 3, positioned at the center of the glazing 1 and at the center of the door 4. The glazing 1 could comprise a plurality of flexible electrical connections, for example to supply a plurality of different areas of the glazing with electrical current and/or an electrical signal.

When the glazing 1 is installed in the vehicle, this (or these) flexible electrical connection(s) 3 extend(s) only into the hidden part HP of the glass pane; it does not (or they do not) extend over the entire visible part VP of the glass pane, for aesthetic reasons. It is (or they are) located completely under the line of sight VL.

This flexible electrical connection(s) 3 is (or are) preferably distinct from the means for allowing the mobility of the glass pane in the final glazing; however, it is possible for such flexible electrical connection(s) 3 to be in direct contact with the means for allowing the mobility of the glass pane in the final glazing, or to be integrated into the means for allowing the mobility of the glass pane in the final glazing.

As can be seen in FIG. 3, regardless of the position of the glass pane 2, the flexible electrical connection(s) 3 extend(s) between the interior face 22 of the glass pane and an adjacent bodywork element, located further toward the interior; the flexible electrical connection(s) 3 do(es) not extend under the edge 21 of the lower rim 26 or farther toward the exterior than the exterior face 20 of the glass pane 2.

As can be seen in FIGS. 2 and 3, the flexible electrical connection 3 has an upstream connector 30 attachable to an inner element 42 fixed to said bodywork and a downstream connector 30′ attachable to the glass pane 2 of the glazing 1. The flexible electrical connection 3 comprises a flexible ribbon cable 31 comprising at least one conductive wire and/or at least one conductive strip 32, 32′ and having a curved lateral shape C, C′ at the connection with the upstream connector 30 and with the downstream connector 30′.

The conductive strips 32, 32′ are made of copper and are here two in number, but there could be more. They are embedded in a flexible plastic material 31 made of polyimide or of polyethylene naphthalate.

The upstream connector 30 and the downstream connector 30′ each comprise a receiving surface S, S′ which is in contact with said flexible ribbon cable 31 and which is curved laterally to produce the curved lateral shape of the flexible ribbon cable.

The receiving surface S, S′ of the upstream connector 30 and the downstream connector 30′ is curved longitudinally and terminates at a proximal end (near the glass pane or the inner element fixed to the bodywork) by a flat part.

The curved lateral shape C, C′ has, seen in cross section, a general V-shape, with a single curve point, preferably located in the middle of the width of said flexible ribbon cable and with an angle α between two wings of the V which is between 60° and 120°; here 90°.

As can be seen in FIG. 5, a downstream connector 30′ (or an upstream connector 30, not shown in detail) is a part made of plastic material manufactured for example by molding and which receives the downstream end of the flexible ribbon cable 31 (respectively the upstream end of the flexible ribbon cable 31). The curved lateral shape C′ (respectively the curved lateral shape C) is made by walls 35′ and 36′ in V on the edge of the connector, with the angle of the V which gradually increases to become a flat wall 37′; this is a pyramidal shape. Unlike the curved lateral shape C′, a flat bottom 38′ is in contact with the glass pane 2 when the flexible electrical connection is attached to the glass pane 2.

Unlike the connection with the flexible ribbon cable, the front connector comprises two cylindrical electrical cables 33, 34 that leave the connector.

Here, the flexible ribbon cable 31 has a flat width of 20.0 mm and a thickness of 25 μm. Its length depends on the path that the downstream connector 30′ must travel between the open position and the closed position of the glass pane.

In the vehicle, the upstream connector 30 is attached to an inner element 42 fixed to the door 4 and the downstream connector 30′ is attached to the glass pane 2 to allow the electrical connection. The upstream connector 30 is therefore fixed in the reference frame of the translatable glazing 1.

The glazing 1, after its manufacture and before its installation in the vehicle, may comprise means intended to protect the flexible electrical connection(s) 3 so that it is not (or they are not) damaged after the manufacture of the glazing 1 and before its (or their) installation in the vehicle.

These means may be temporary plastic or cardboard elements, which are removed at the time the glazing is installed in the vehicle.

Preferably, to effectively protect the flexible electrical connection(s) 3 without using a disposable temporary element, the upstream connector 30 and the downstream connector 30′ are configured to be temporarily attachable to each other. Thus, after installing the glazing in the vehicle, it is sufficient to detach the upstream connector 30 to attach it to the electrical connection means provided in the environment of the inner element 42.

The flexible electrical connection 3 has, along its length, a single fold P, having a radius of curvature r between 0.2 and 20.0 mm, preferably between 5.0 and 15.0 mm; here 10.0 mm.

This fold P is provided in the flexible ribbon cable and changes position along this flexible ribbon cable when the glazing moves relative to the bodywork.

The fold P is in position Pa, near the upstream connector 30 when the glass pane 2 is closed (position of the glass pane 2a in FIG. 3) and is in position Pb, near the downstream connector 30′ or 30′b when the glass pane 2 is open (position of the glass pane 2b in FIG. 3 and position of the glass pane 2 in FIG. 4).

As can be seen in FIG. 2, at the location of the longitudinal fold P, the conductive strip does not have a curved lateral shape; the conductive strip is substantially flat laterally.

In these two positions: Pa and Pb, as well as in all the intermediate positions between these two extreme positions, the fold has a constant thickness equal to twice the radius of curvature r, or here a fold thickness P of 20.0 mm.

In the two extreme positions of the glazing, 2a closed and 2b open, as well as in all the intermediate positions between these two extreme positions, the flexible ribbon cable 31a, 31b is located farther toward the interior than the edge of the lower rim 26a, 26b; the flexible ribbon cable 31 is never in contact with this edge, nor with the inner face 22a, 22b of the glass pane 2a, 2b, nor of course with the edge face located between that lower rim and that edge; there is thus no risk of the flexible ribbon cable 31 being damaged.

The inner element 42 is an interior guide for the flexible electrical connection 3; it prevents it from going further inward. This is a plastic plate of rectangular shape and positioned elongated in the height direction so that the flexible electrical layer 31 slides easily on its surface.

A pane-holder has, for example, in cross section along a vertical axis, substantially a U-shape that is fitted to a longitudinal part of the bottom rim 26.

A pane-holder 6, 6′ can thus have:
a U-shaped part consisting of two parallel walls connected to their base and forming a longitudinal groove, with the base of this U facing the glass pane edge 21. The pane-holder is intended to be connected to a motorized driving system, which is not shown, in order to allow the glazing to be raised and lowered in the door of the vehicle. The U-shaped part fits the bottom rim 26.

In FIG. 1, the pane-holders 6, 6′ do not comprise a fastening hole, but it is possible that one or each pane-holder comprises a fastening hole.

The one (or more) pane-holder(s) 6, 6′ is (are) adhesively bonded with the aid of a bead of adhesive, for example polyurethane, then “fitted” onto the glass pane, that is it is (they are) positioned so that the glass pane is present in the U shape, in abutment or not, by inserting between said parallel walls and the glass pane an insert made of plastic, such as for example of polypropylene.

In a variant, an in-situ injection of adhesive intended to form the insert is proposed, which is made of thermoplastic hot-melt resin, for example based on polyamide.

The hot-melt resin used has an elastic limit of about 5.5 N/mm² and a breaking strength of 11 N/mm², calculated according to standard DIN 53455. It must be used at a temperature of about 220° C. and has at this temperature a viscosity in the order of 5000 mPa·s, measured according to standard ASTM D 3236.

The pane-holders used are preferably made of plastic material, such as for example made of polyamide and in particular of PA 66, filled with glass fibers; they may optionally be an aluminum alloy. By way of example, with a 6060 aluminum alloy (AGS), a vertical compressive force of 30 to 50 tons is enough, that is correlated to the size of the glass pane holders, stresses of about 150 GPa for U-shaped glass pane holders of overall dimension of about 40×30 mm and of about 450 GPa for U-shaped glass pane holders of overall dimension of about 60×60 mm.

The present invention is described in the preceding text by way of example. Of course, those skilled in the art are capable of implementing different variants of the invention without departing from the scope of the patent such as defined by the claims.

1. A flexible electrical connection for a vehicle glazing movable in translation relative to a bodywork element of said vehicle, said flexible electrical connection having, along its length, an upstream connector attachable to an inner element fixed to said bodywork element and a downstream connector attachable to a glass pane of said glazing, the flexible electrical connection comprising a flexible ribbon cable comprising at least one conductive wire and/or at least one conductive strip and having a curved lateral shape on itself to the connection with said upstream connector and with said downstream connector.

2. The flexible electrical connection according to claim 1, wherein said upstream connector and said downstream connector each comprise a receiving surface which is in contact with said flexible ribbon cable and which is curved laterally.

3. The flexible electrical connection according to claim 2, wherein said receiving surface of said upstream connector and/or said downstream connector is curved longitudinally and terminates at a proximal end by a flat part.

4. The flexible electrical connection according to claim 1, wherein at least one of said curved lateral shapes, has, seen in cross section, a general V-shape, with an angle between two wings of the V which is between 60° and 120°.

5. The vehicle glazing comprising a glass pane, a system configured to allow mobility of said glass pane in translation relative to a bodywork element of said vehicle and at least one flexible electrical connection according to claim 1, wherein said downstream connector is attached to said glass pane (2).

6. The glazing according to claim 5, wherein said glass pane comprises a heater configured to heat said glass pane and/or a system configured to lighten and darken said glass pane and/or to change a hue of said glass pane.

7. A vehicle equipped with a glazing comprising a glass pane, a system configured to allow mobility of said glass pane in translation relative to the bodywork element of said vehicle, and at least one flexible electrical connection according to claim 1, wherein said upstream connector is attached to an inner element fixed to said bodywork element and said downstream connector is attached to said glass pane.

8. The vehicle according to claim 7, wherein said flexible ribbon cable has, along its length, a fold having a radius of curvature between 0.2 and 20.0 mm.

9. The vehicle according to claim 7, wherein said glass pane comprises a heater configured to heat said glass pane and/or a system configured to lighten and darken said glass pane and/or to change a hue of said glass pane.

10. The vehicle according to claim 7, wherein said flexible ribbon cable extends along its length in a direction parallel to an essential component of a direction of translation of said glass pane.

11. The vehicle according to claim 7, wherein said inner element is an interior guide for said flexible ribbon cable.

12. The flexible electrical connection according to claim 4, wherein each curved lateral shape has, seen in cross section, a general V-shape, with an angle between two wings of the V which is between 60° and 120°.

13. The flexible electrical connection according to claim 4, wherein the angle is between 80° and 100°.

14. The flexible electrical connection according to claim 4, wherein the angle is 90°.

15. The vehicle according to claim 8, wherein the radius of curvature is between 5.0 and 15.0 mm.

16. The vehicle according to claim 10, wherein each flexible ribbon cable extends along its length in a direction parallel to an essential component of the direction of translation of said glass pane.
